(19) United States
(12) Patent Application Publication
(10) Pub. No.: US 2022/0282002 A1
(43) Pub. Date: Sep. 8, 2022

(54) USE OF CATALYTIC ION EXCHANGE RESINS TO EFFECTIVELY DECOLORIZE POLYSACCHARIDES DERIVED FROM LIGNOCELLULOSIC BIOMASS

(71) Applicant: Prenexus Health, Inc., Gilbert, AZ (US)

(72) Inventor: Kevin A. Gray, San Diego, CA (US)

(73) Assignee: Prenexus Health, Inc., Gilbert, AZ (US)

(21) Appl. No.: 17/684,856

(22) Filed: Mar. 2, 2022

Related U.S. Application Data
(60) Provisional application No. 63/155,450, filed on Mar. 2, 2021.

(51) Int. Cl. C08B 37/00; A23L 29/206

(52) U.S. Cl. CPC C08B 37/0057; A23L 29/206

(57) ABSTRACT

This invention relates to the isolation and purification of nutritional supplements and prebiotics, such as xylo-oligosaccharides, and specifically the removal of color bodies, said xylo-oligosaccharides sourced from from ligno-cellulosic feedstocks such as sugar cane and sugar cane bagasse. Removal of color bodies provides greater purity in certain xylo-oligosaccharides as described. This process can also be applied to non-sugar cane feedstocks such as agricultural residues (wheat straw, corn stover, rice straw, etc.), purpose grown crops including but not limited to sugar cane, sorghum, Miscanthus, and woody biomass such as poplar.

This application claims the benefit of U.S. Provisional application No. 63/155,450, filed on Mar. 2, 2021, which is hereby incorporated herein in its entirety.

### TECHNICAL FIELD

This invention relates to the isolation and purification of nutritional supplements and prebiotics, such as xylo-oligosaccharides, and specifically the removal of color bodies, said xylo-oligosaccharides sourced from from ligno-cellulosic feedstocks such as sugar cane and sugar cane bagasse. This process can also be applied to non-sugar cane feedstocks such as agricultural residues (wheat straw, corn stover, rice straw, etc.), purpose grown crops including but not limited to sugar cane, sorghum, Miscanthus, and woody biomass such as poplar.

### BACKGROUND

Co-delivery of nutritional supplements and vitamins is a challenging enterprise. Oftentimes nutritional and dietary supplements are formulated such that one or more active components can be delivered to a subject, either simultaneously or stepwise.

However, as more components are added to the formulation, it becomes more difficult with respect to delivery to the subject and chemical stability.

If a way could be found to combine both production and delivery of active materials comprising a prebiotic, a postbiotic and an antioxidant in a single product, this would serve as a useful contribution to nutrition science.

Xylo-oligosaccharides are a nutrient (carbon) source for beneficial anaerobic micro-organisms in the digestive tract of the host. These microbes in turn produce metabolites that are beneficial to the host which then provide a physiological benefit to the host. Microbial metabolites include, but are not limited to, short chain fatty acids (SCFA) including acetic, butyric, propionic, etc acids. Due to providing nutrition to gut beneficial microbes xylooligosaccharides are referred to as “prebiotics”. See, Saville, B. A. and Saville, S., Appl. Food Biotech. (2018) 5(3): 121-130; Saville, S. and Saville, B. A., Agro Food Industry Hi Tech (November/December 2018) 29(6): 36-38.

If a way could be found to use xylooligosaccharides to deliver other needed nutrients to an organism, such as vitamins or antioxidants, this would be considered a contribution to the nutritional and medical arts.

“Color bodies” encompass certain organic impurities which are found to be undesirable in a consumable dietary product or nutritional product. There is evidence that some portion of the color bodies in crude XOS mixtures are covalently linked to the XOS backbone (U.S. Pat. No. 10,612,059, and U.S. pat. appl. publ. 2020/0216574 A1, both to Richard, et al.) in which methods are described using alkaline peroxide treatment as part of the purification scheme. Alkaline peroxide treatment was employed to remove polyphenols and other color compounds related to lignin and degradation products from the arabinoxylan molecule, i.e. a polysaccharide consisting of a xylan backbone with arabinose branches. The free color bodies are then removed from the mixture using a combination of filtration and ion exchange chromatography.

Another disclosure generally describes the production of mixtures of sucrose and XOS. See, WO 2015/164948 A1 to Saville, and references cited therein; which was later published as Australian Patent No. 2015252695 B2.

Therefore, if a way could be found to prepare xylo-oligosaccharides, with concomitant removal of color bodies, without a distinct unit operation like alkaline hydrogen peroxide treatment, this would be a contribution to the chemical and nutritional arts.

### SUMMARY

In an embodiment, a method is described for preparing, purifying, and/or isolating xylo-oligosaccharides, and specifically the removal of color bodies, comprising the steps of: (a) cooking biomass feedstock at an elevated temperature (>150 ° C.) under pressure for an extended period of time (>30 min) in water to provide cooked solids in an aqueous liquor, (b) separating the aqueous liquor from the cooked solids using standard liquid/solid separation equipment such as a screw press or filter press to provide a crude mixture, (c) isolating and purifying xylo-oligosaccharide (XOS) from the crude mixture using a combination of filtration steps (selected from the group consisting of micro-, nano- and ultrafiltration) and chromatographic separation (selected from the group consisting of adsorption, ion exchange, gel permeation chromatography, and reverse phase chromatography), and (d) concentrating XOS-containing eluent, and (e) drying to provide XOS as a powder.

In another embodiment, a method is described for making a xylo-oligosaccharide material, comprising the steps of: (a) providing a feedstock xylo-oligosaccharide material in aqueous solution including xylose monomer units comprising formula (I):

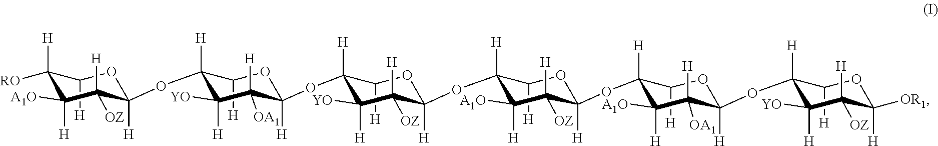

wherein R and R₁ are each independently selected from hydrogen or one or more xylose monomer units,
A₁ is selected from hydrogen or acetyl, Y is selected from the group consisting of hydrogen, arabinose (arabinosyl), galactose (galactosyl), ribose (ribosyl), mannose (mannosyl), glucuronic acid (glucuronosyl), and glucose (glucosyl), Z is selected from the group consisting of hydrogen, glucuronic acid (glucuronosyl), galacturonic acid (galacturonosyl), and mannuronic acid (mannuronosyl), optionally, Y and Z can be exchanged one for another, and wherein either of Y or Z is further substituted on a sugar hydroxyl as a cinnamate ester, the positions of the phenyl group -meta, -para, -meta are each independently selected from hydrogen, hydroxyl, or methoxy;
(b) adding the xylo-oligosaccharide solution to an ion-exchange resin; and
c) eluting the xylo-oligosaccharide solution to provide a decolorized solution containing purified xylo-oligosaccharide. Optionally, the decolorized solution can be dried to a powder containing purified xylo-oligosaccharide.

### BRIEF DESCRIPTION OF THE FIGURES

FIG. 1 depicts UPLC/ELSD/MS-TIC spectra of PRENEXOS™. Top trace: ELSD chromatogram; bottom trace: ES-TIC spectrum. The sample shows an XOS degree of polymerization (DP) of approx. 2 to >10 (10+). In one useful embodiment, the xylooligosaccharide mixture has a degree of polymerization “DP” of about 3 to 12. In another useful embodiment, the DP range can include greater than DP12, i.e. 12+.

FIG. 2 depicts ES mass spectra of PRENEXOS™ showing an acetylated xylo-oligomer pattern (DP4-DP7).

FIG. 3 depicts, in an in vitro gastric model of the colon (TIM-2), the effects of three doses of PRENEXOS™ at 1.0 g/day, 1.5 g/day, and 3.0 g/day compared to control medium (STEM). Cumulative production of short chain fatty acids (SCFAs) is expressed as SCFA produced per gram of XOS provided per day. Acetate: solid squares; propionate: triangles; butyrate: X's. X-axis is hours: 24 h, 48 h, 72 h.

FIG. 4 is a Table summarizing performance testing of FPA51, FPA90, FPA98 and FPA22.

### DETAILED DESCRIPTION

Xylo-oligosaccharides are derivatives of the hemicellulose fraction found in plant material. Hemicellulose is a complex structural polysaccharide that, in certain plants like sugar cane, has a xylan backbone with branches of other sugars such as arabinose, galactose, mannose, glucuronic acid and sometimes glucose. In addition to the sugar branches hemicellulose is connected to acetyl, ferulic and diferulic acids that link xylan chains to lignin.

In its principal embodiment, the invention comprises a xylooligosaccharide (PRENEXOS™, available from Prenexus Health, Inc., Gilbert, Ariz.), a mixture of xylo-oligosaccharides of various chain lengths (a.k.a. PreneXOS™, Prenexus XOS™, and XO595®). In one useful embodiment, the xylooligosaccharide mixture has a degree of polymerization “DP” of about 3 to 12, based on xylose monomers. In another useful embodiment, the DP range can include greater than DP12, i.e. 12+, based on xylose monomers.

In a preferred embodiment, PRENEXOS™ is derived from sugar cane using a process that has been certified organic and includes no chemical addition except for water. In other embodiments, XOS may be prepared using other plant-based materials or feedstocks, such as corn cobs or wheat straw, for example.

PRENEXOS™ is not a simple straight chain XOS but also contains branches of sugar residues, and substitution by acetate and polyphenolics as esters, therefore achieving co-delivery of the short chain fatty acid (SCFA) acetic acid, and also antioxidant polyphenolic compounds such as ferulic acid, p-coumaric acid, 3,4-dihydroxycinnamic acid, and 3,5-dimethoxy-4-hydroxycinnamic acid.

A representative structure of PRENEXOS™ is shown in Formula (I):

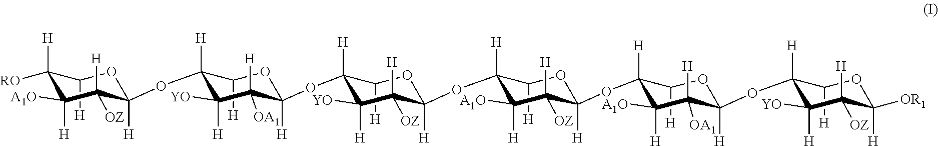

wherein R and R₁ are each independently selected from hydrogen or one or more xylose units. In an embodiment, the xylose are (beta-1,4-xylose, or beta-1,4-xylosyl) residues. Other configurations of the polysaccharide are contemplated. Xylose units may be removed from Formula (I) when it occurs in a mixture of oligosaccharides, and merely substituted with a hydrogen atom.

In Formula (I), A₁ is selected from hydrogen or acetyl.

In Formula (I), Y is selected from hydrogen, arabinose (arabinosyl), galactose (galactosyl), ribose (ribosyl), mannose (mannosyl), glucuronic acid (glucuronosyl), or glucose (glucosyl), and the like, in any of several linkage configurations (taking into account mutarotation and steric effects). Z is selected from hydrogen, glucuronic acid (glucuronosyl), galacturonic acid (galacturonosyl), mannuronic acid (mannuronosyl), and the like, or methylated or alkylated derivatives thereof, in any of several linkage configurations.

In an embodiment, Y and Z can be exchanged one for another. For example, instead of -OY at the 4-carbon position of xylose, it may be at the 3-carbon position, and vice versa. For example, instead of -OZ at the 3-carbon position of xylose, it may be at the 4-carbon position, and vice versa.

In an embodiment, either of Y or Z may be further derivatized (i.e., substituted on a sugar hydroxyl) as a cinnamate ester, or derivatized or substituted cinnamate ester (i.e., cinnamoyl substitution of a sugar hydroxyl). In an embodiment, the phenolic side chains may comprise other cinnamate type structures. For example, if the positions of the phenyl group -meta, -para, -meta are considered in that order as R₁₁, R₁₂, and R₁₃ respectively, then each of R₁₁, R₁₂, and R₁₃ are each independently selected from hydrogen, hydroxyl (—OH), or methoxy (—OCH₃).

It may be understood that the XOS materials described herein is based on a hemicellulose fraction and these materials comprise a mixture of compounds having varying chain lengths in terms or the sugar, i.e. saccharide backbone, most of the sugar residues being xylose in xylo-oligosaccharide. Thus, as used herein the terms “oligosaccharide”, “oligosaccharides”, and “XOS” may be construed as referring to a compound or group of compounds having varying chain lengths and branch points in the carbohydrate backbone.

In one embodiment, a representative structure of PRENEXOS™ is shown in Formula (Ia):

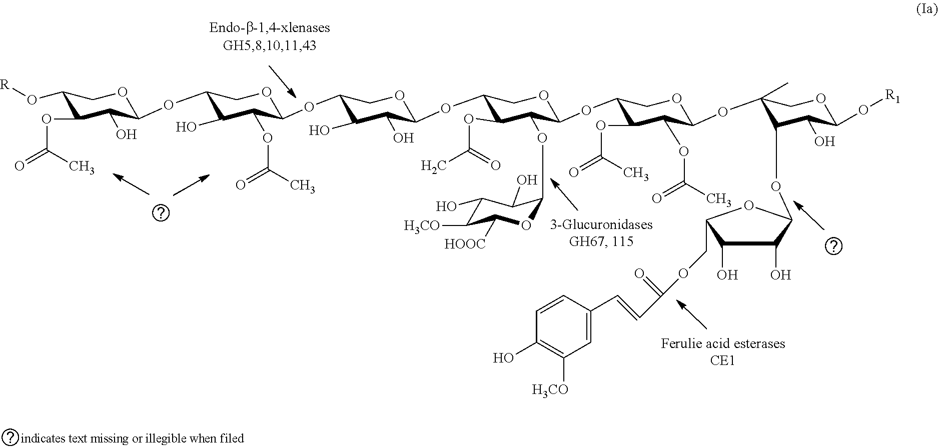

wherein R and R₁ are each independently selected from hydrogen or one or more xylose units.

It should be understood that an oligosaccharide is by definition a compound or material having varying chain lengths in terms or the sugar, i.e. saccharide backbone, most of the sugar residues being xylose in xylo-oligosaccharide. Thus, as used herein the terms “oligosaccharide”, “oligosaccharides”, and “XOS” may be construed as referring to a compound or group of compounds having varying chain lengths and branch points in the carbohydrate backbone.

In an embodiment, the phenolic side chains may comprise other cinnamate type structures. For example, if the positions of the phenyl group -meta, -para, -meta are considered in that order as R₁₁, R₁₂, and R₁₃ respectively, then each of R₁₁, R₁₂, and R₁₃ are each independently selected from hydrogen, hydroxyl (—OH), or methoxy (—OCH₃).

Table 1 shoes the characterization of a representative sample of PRENEXOS™ having Formula (I).

Characterization of XOS

TABLE 1

| | | Measured | |
|---|---|---|---|
| Component | Specification | Amount | Analysis Method |
| Appearance | Powder | Powder | Visual |
| Color | Off-white to | Off-white | Visual, ICUMSA |
| | light tan | | |
| Total solids, wt % | >93 | 97.7 | AOAC 925.45 |
| Water activity | | 0.11 | ISO 18787: 2017 |
| Xylooligosaccharides, | >75 | 85 | NREL/TP-510-42618 |
| wt % | | | (HPLC) |
| Carbohydrate | | | NREL/TP-510-42618 |
| Monomers | | | (HPLC) |
| Glucose/Fructose/ | <12 | 0 | NREL/TP-510-42618 |
| Sucrose/Xylose, wt % | | | (HPLC) |
| Polyphenols and | <3.0 | 0.57 | AOAC 986.13 and |
| organic acids, wt % | | | Methods of |
| | | | Enzymology, |
| | | | 299, pp 152-178 |
| | | | (1999) |

Batch number: XOS-211104

LC-MS analysis carried out by the National Renewable Energy Laboratory in Golden, CO according to Xiong, W., Reyes, L. H., Michener, W. E., and Maness, P.-C., Engineering cellulolytic bacterium Clostridium thermocellum to co-ferment cellulose- and hemicecellulose-derived sugars simultaneously, Biotechnology and Bioengineering (2018) 115 (7), 1755-1763.

Degree of Polymerization and Acetylation

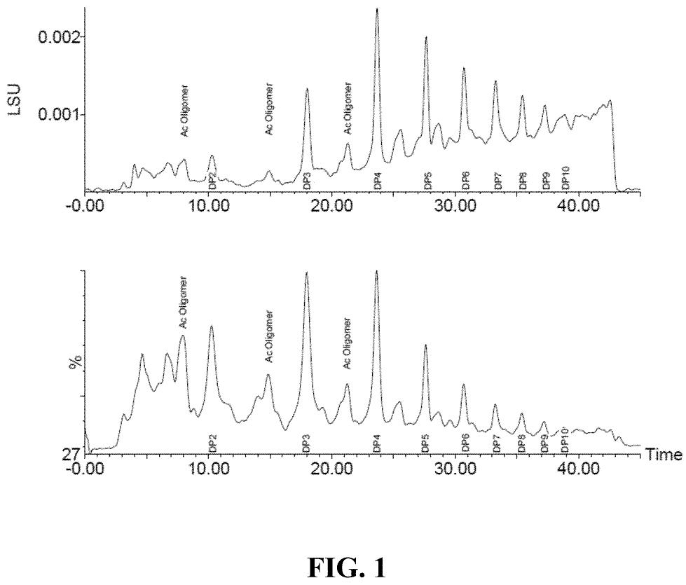

FIG. 1 shows UPLC/ELSD/MS-TIC chromatogram & spectra of PreneXOS™ The sample shows an XOS degree of polymerization (DP) of approx. 2 to >10 (10+). The peaks eluting between the XOS chains are identified as acetylated xylo-oligomers (i.e., A₁ is acetyl in Formula (I)).

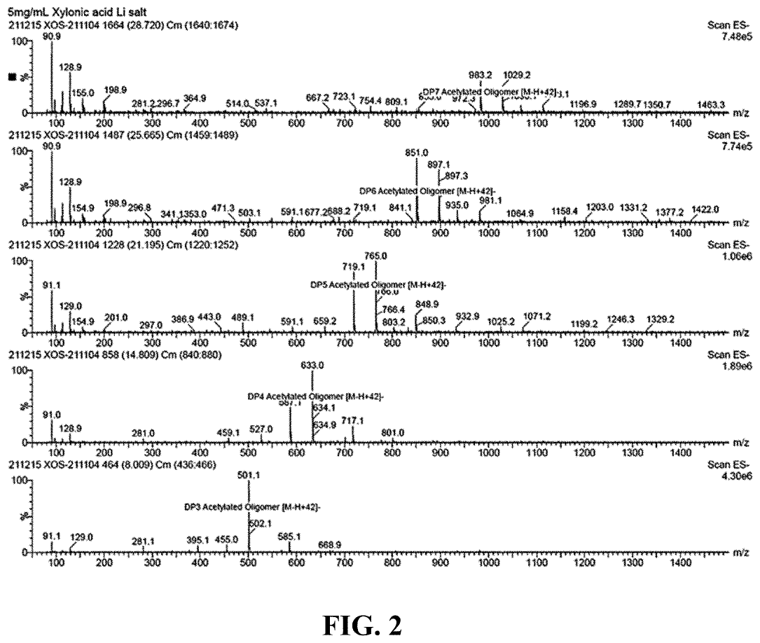

FIG. 2 show the extracted mass spectra of some of the peaks eluting between the xylo-oligomers (DP4-DP7) of XOS-211104 show an acetylated xylo-oligomer pattern.

Chemical Analysis of Acetylation and Non-Xylose Sugar Branches

Table 2 shows the mol/mol ratios of acetate and certain sugar branches including galactose (galactosyl) and arabinose (arabinosyl) which are present in materials having Formula (I).

TABLE 2

| XOS | Xylose/ | Xylose/ | Xylose/ |
|---|---|---|---|
| Substitution/Branching | acetate | galactose | arabinose |
| Average (mol/mol) | 5.9 | 38.2 | 28.5 |
| Standard deviation | 1.4 | 6.0 | 8.8 |

Based on Table 2, on average, every 6^{th} xylose in PreneXOS™ is acetylated while every 40^{th} appears to have a galactose side branch and every 30^{th} appears to have an arabinose side branch, when the material is taken as a whole, in any given sample.

Due to providing nutrition to gut microbes xylooligosaccharides are referred to as “prebiotics”. As stated above, xylooligosaccharides are a nutrient (carbon) source for beneficial anaerobic micro-organisms in the digestive tract of the host. These microbes in turn produce metabolites that are beneficial to the host which then provide a physiological benefit to the host. Microbial metabolites include, but are not limited to, short chain fatty acids (SCFA) including acetic, butyric, propionic, etc acids. SCFA are sometimes referred to as “postbiotics” since they themselves are one of direct sources of the physiological effect on the host. Another class of compounds such as polyphenolics are referred to as “antioxidants” since they “scavenge” reactive oxygen species that are detrimental. Antioxidants also provide a beneficial effect to the host. PRENEXOS™ is composed of a backbone of xylose monomers linked together but also containing acetyl esters and ferulic acid esters. All three components are produced together in a single unit as opposed to separately manufactured.

Thus, in another embodiment, the invention relates to the co-production and co-delivery of a prebiotic, a postbiotic and an antioxidant that are chemically linked and thus can be delivered as a single product instead of a blend of individual molecules. The product, PRENEXOS™, is used as a nutritional supplement and/or food ingredient that improves digestive health and overall wellness.

Xylooligosaccharides are derivatives of the hemicellulose fraction found in plant material. Hemicellulose is a complex structural polysaccharide that, in certain plants like sugar cane, has a xylan backbone with branches of other sugars such as arabinose, galactose, mannose, glucuronic acid and sometimes glucose. In addition to the sugar branches hemicellulose is connected to acetyl (i.e. acetylated), ferulic and diferulic acids and p-coumaroyl that link xylan chains to lignin. Sugar cane has hydroxycinnamic acid (ferulic, coumaric and sinapic acids) involved in crosslinking xylan and lignin molecules. During Prenexus Health's (i.e., the applicant's) high temperature “cook” process that produces PRENEXOS™, acetyl esters are hydrolyzed releasing acetic acid into solution decreasing the pH. The low pH and high temperature then catalyzes the hydrolysis of glycosidic linkages between xylose subunits in the xylan chain resulting in shorter chain, water soluble xylo-oligosaccharides. However, the process conditions are not severe enough to completely debranch XOS therefore some acetyl and ferulic acid esters remain as do branches of other sugars and various polyphenolics and lignin fragments. The present application uses a series of filtration steps (micro-, nano- and ultra-) along with ion exchange chromatography to isolate XOS from the crude extract. While ion exchange chromatography is effective at removing color bodies we observed an increase in free acetic acid after use of the resin when run under alkaline conditions. Mass balance studies showed that the ion exchange process catalyzed the conversion of bound acetate to unbound acetic acid. Even though the ion exchange process catalyzes the partial de-esterification of acetyl groups some still remain covalently bound to the XOS backbone. Furthermore, some color still remains bound to the XOS background which is an indicator of polyphenolics being present.

In addition to the xylose backbone, the XOS may contain glucuronic acids, connected at the 2-position of xylose, and arabinose at the 3-position which may be esterified as shown in Formula (I).

According to F. Shahidi and J. Yeo, Insoluble-Bound phenolics in food, Molecules (2016) 21:1216, in plant cell walls “phenolic compounds can form covalent bonds with cell wall substances such as cellulose, hemicellulose, arabinoxylans, structural proteins and pectin through ester, ether and C—C bonds. The carboxyl group of phenolic acids such as benzoic and cinnamic acids can form ester bonds with hydroxyl groups of cell wall substances and C—C bonds as well when they directly create covalent bond between carbon atoms of phenolics and carbon atom of cell wall substances.”

Chemical analysis of PRENEXOS™ revealed the presence of bound phenolic groups (in addition to acetate groups). A standard assay is performed to detect the presence of polyphenolics that involves a methanol extraction and then a colorimetric assay. Methanol will dissolve “free” phenolic groups in solution and therefore does not detect methanol insoluble polyphenolics (i.e. those bound to XOS); if we use water as the solvent we measure a much higher phenolic content and our interpretation of those data is that water dissolves all components (including XOS) and therefore measures bound and free.

Table 3 shows the results of the results from the polyphenolic assay for one batch of product produced in the manufacturing plant.

TABLE 3

| | Total phenolic content | Free phenolic content |
|---|---|---|
| Sample | (% solids) | (% solids) |
| XOS200918 | 0.91 | 0.04 |

The difference between “total phenolic content” and “free phenolic content” is that which is bound to XOS. Per observation, “total phenolic content” is measured by dissolving XOS into water and carrying out the assay whereas “free phenolic content” is measured by extracting powdered XOS with methanol (XOS is insoluble in MeOH whereas phenols are soluble in MeOH) and carrying out the assay on the MeOH fraction. The numbers are wt percent of the solids.

Thus, one disadvantage of using PRENEXOS™, manufactured in this way is the presence of color. The final product is not a white to off-white product but yellow to tan. The yellow color of PRENEXOS™ is pH dependent. Under alkaline conditions a solution of PRENEXOS™ in water is yellow whereas under neutral to acidic conditions the solution is colorless.

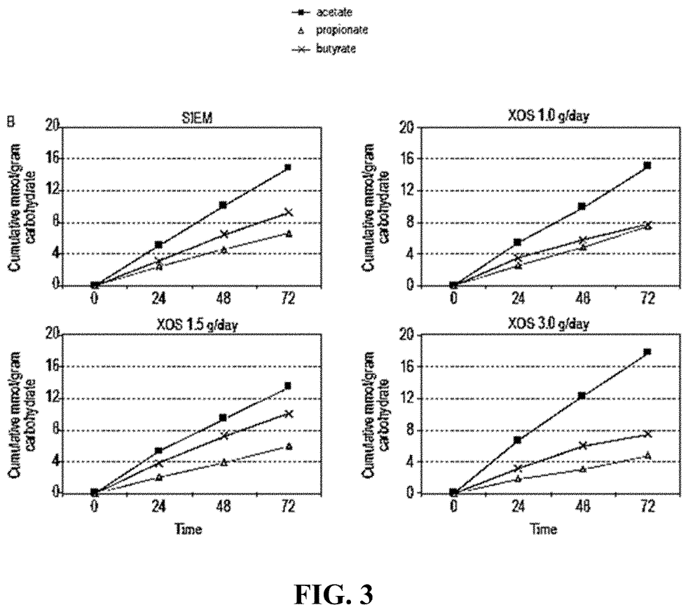

As a further example, a study was performed using an in vitro model of the colon (“TIM-2”) to simulate human adults. The results are reported in K. Venema, et al., “Xylo-oligosaccharides from sugarcane show prebiotic potential in a dynamic computer-controlled in vitro model of the adult human large intestine”, Beneficial Microbes (2020) 11(2): 191-200, which is herein incorporated by reference in its entirety for all purposes, along with the references cited therein. The effects of three doses of PreneXOS™ at 1.0 g/day, 1.5 g/day, and 3.0 g/day were compared to control medium (SIEM). As shown in FIG. 3, acetate increased in a dose dependent manner at the 3.0 g dose.

Due to providing nutrition to gut microbes xylooligosaccharides are referred to as “prebiotics”. As stated above, xylooligosaccharides are a nutrient (carbon) source for beneficial anaerobic micro-organisms in the digestive tract of the host. These microbes in turn produce metabolites that are beneficial to the host which then provide a physiological benefit to the host. Microbial metabolites include, but are not limited to, short chain fatty acids (SCFA) including acetic, butyric, propionic, etc acids. SCFA are sometimes referred to as “postbiotics” since they themselves are one of direct sources of the physiological effect on the host. Another class of compounds such as polyphenolics are referred to as “antioxidants” since they “scavenge” reactive oxygen species that are detrimental. Antioxidants also provide a beneficial effect to the host. PRENEXOS™ is composed of a backbone of xylose monomers linked together but also containing acetyl esters and ferulic acid esters. All three components are produced together in a single unit as opposed to separately manufactured.

In a preferred embodiment, one of the steps in the production of xylo-oligosaccharides (XOS) from ligno-cellulosic biomass involves the removal of so-called “color bodies” such that the final product is a white to off-white powder or a colorless concentrated syrup.

The removal of color makes the product more aesthetically pleasing as well as increases the overall purity of XOS in the final product. The source of color can either be lignin fragments and/or degradation products that are generated during the cook process or polyphenolics that are bound or unbound to structural polysaccharides (cellulose and hemicellulose) in the plant tissue. Color can be removed by a filtration process (nanofiltration, ultrafiltration, etc) or by a chromatographic step (for example ion exchange or adsorption). Only “free” color bodies can be removed using the aforementioned methods, however, color that is covalently linked to XOS must first be released into solution before removal. This disclosure proposes to use a catalytic ion exchange resin in the place of strong oxidizing agents such as alkaline peroxides to effect both the release of bound color bodies and the adsorption of free color from the crude mixture.

Detection of color bodies may be carried out by standard photometric absorbance methods at about either 360 nm or 420 nm, or both. In certain preferred embodiments, the absorbance may be measured at 366 nm (OD₃₆₆), or 420 nm (OD₄₂₀).

Certain ion exchange resins are designed to carry out catalysis in addition to binding organics. Useful ion exchange resins include, but are not limited to, anion and cation exchange resins such as Amberlyst 15, 18, 35, 36, XN1010, 21; Amberlite 26, IR 120, IRA 400, IRA 401, IRA 410, IRA 918, 958; Amberlite FPA22, 40, 42, 51, 53, 54, 55, 555, 58, 66, 77, 90, 900 and 98; Amberlite FPC88, 66, 68, Dowex resins, Dianion resins, Imac resins, and the like. For example, Amberlite FPA51 (available from Dow-Dupont, Wilmington, Del.) is a weak base anion exchange resin but does not contain exchangeable ionic sites and functions as an acid adsorber. Amberlite FPA 51 has been specifically designed for the deashing and deacidification of liquid food streams. It is the product of choice for the deashing and decolorization of glucose, fructose and related starch-based sweeteners. Amberlite FPA 51 is a macroreticular, weakly basic anionic exchange resin containing a tertiary amine functionality on the macroreticular crosslinked polystyrene. Amberlite FPA-51 is a derivative of Amberlyst A21 that is used in base-catalyzed reactions. It was observed that under certain operating conditions Amberlite FPA-51 catalyzes the deacetylation of XOS releasing acetic acid into solution. It has also been observed that the Amberlite FPA51 effectively removes most of the color bodies from a crude XOS mixture by first cleaving the chemical bonds that attach color to XOS and then, secondly, adsorbing the color bodies. Therefore, the resin serves a dual function in accordance with this disclosure. Cleaving the chemical bond between the color bodies and XOS is the novel aspect and was not expected. Certain properties of ion exchange resins are discussed in G. Gelbard, “Organic synthesis by catalysis with ion-exchange resins,” Ind. Eng. Chem. Res. (2005) 44: 8468-8498, incorporated by reference herein.

As discussed above, xylo-oligosaccharides are derivatives of the hemicellulose fraction found in plant material. Hemicellulose is a complex structural polysaccharide that, in certain plants like sugar cane, has a xylan backbone with branches of other sugars such as arabinose, galactose, mannose, glucuronic acid and sometimes glucose. In addition to the sugar branches hemicellulose is connected to acetyl, ferulic and diferulic acids that link xylan chains to lignin.

During the high temperature “cook” process, acetyl esters are hydrolyzed releasing acetic acid into solution decreasing the pH. The low pH and high temperature then catalyze the hydrolysis of glycosidic linkages between xylose subunits in the xylan chain resulting in shorter chain, water soluble xylo-oligosaccharides.

However, the process conditions are not severe enough to completely debranch XOS therefore some acetyl and ferulic acid esters remain as do branches of other sugars and various polyphenolics and lignin fragments.

A series of filtration steps (micro-, nano- and ultra-) were used along with ion exchange chromatography to isolate XOS from the crude extract. The final step is anion exchange using Amberlite FPA-51 which is intended to decolorize and deacidify the product.

While Amberlite FPA-51 is effective at removing color bodies, an increase in acetic acid was observed after use of the resin. Mass balance studies showed that the ion exchange process catalyzed the conversion of bound acetate to unbound acetic acid and that the resin did not adsorb the resultant acetic acid.

Without intending to be bound by any theory, an experiment was designed to compare various resins. To test one hypothesis that Amberlite FPA51 is catalyzing the release of color bodies from XOS prior to adsorption to the resin, Amberlite FPX66 polymeric adsorbent was used in the place of Amberlite FPA51. Amberlite FPX66 is a non-functionalized, macroporous resin that is used to “purify and decolorize food-additive streams” but does not carry out base-catalysis so would not cleave chemical bonds. It was observed that some fraction (not quantified) of color was removed from crude XOS but the eluent was still colored suggesting color bodies still bound to XOS. The preliminary interpretation is that FPX66 only binds “free” color bodies but cannot remove “bound” color bodies from the XOS backbone in a similar fashion as FPA51.

The present method uses Amberlite FPA51 in the place of strong oxidizing agents, such as alkaline peroxide, to effect both the release of bound color bodies and the adsorption of free color from the crude mixture. The advantage of using Amberlite FPA51 over alkaline peroxide treatment is use of a resin greatly simplifies the operation which can be carried out in a standard chromatography system in a flow-through system instead of a separate reactor that requires elevated temperature, use of potentially harmful chemicals and further processing to remove alkaline peroxide prior to subsequent processing steps.

One potential drawback in the use of Amberlite FPA51 is that, in addition to catalyzing the release of polyphenolics from the XOS backbone, it also appears to catalyze the deacetylation of XOS during the process which results in an increase of acetic acid (acetate) in the final product. Alternative methods must then be used to remove the “free” acetate prior to the final drying stage due to acetic acid causing issues with drying and meeting product specification requirements.

Nevertheless, Amberlite FPA51 is also designed to be a deacidification resin; i.e. it should adsorb any acetic acid that is generated during the process. However, current process conditions (pH >10) may prohibit adsorption of acetic acid to the resin.

Therefore, in one embodiment it is envisioned to run the process in two stages in which stage 1 is run at pH>10 to remove color bodies (and acetate) from the XOS molecule, and then at stage 2 reduce the pH of the resin and re-run the process to effectively bind acetic acid.

The process described herein overcomes the potential disadvantages by running a two step ion exchange process in which the first step is high pH resulting in release of “color bodies” and acetic acid, and the second step is lower pH binding “free acetic acid” thereby making it possible to eliminate a further downstream process which currently results in high XOS loss.

Ion Exchange Regeneration

Through the passing of large quantities of the extracted and filtered liquid generated from upstream processing in the present process, the color removing properties of the ion exchange resins held inside containment columns will be diminished to the point of being ineffective or inefficient and will require a regeneration process. The regeneration process serves several purposes. First, it removes and washes the bound color containing compounds from the resin columns. Second, it recharges the resins so that they have the proper chemical charge to attract and bind the color compounds desired for removal. And finally, it provides a microbial control step to ensure the columns are safe for continued use in the production of a food ingredient

In summary, Amberlite FPA51 is designed as a catalytic resin which also adsorbs certain acids. In the plant material itself the hemicellulose fraction is covalently linked to non-xylose molecules including other sugars and non-sugar components such as lignin and polyphenolics. The chemical bonds between the xylose back bone and the non-xylose components need to be cleaved in order to isolate a more pure XOS. Typically this chemistry occurs during the “cook process”, i.e. thermochemical treatment (auto-hydrolysis) that extracts insoluble components into the soluble phase. However, some amount of these chemical bonds remain after the cook process and standard physical separation will not effectively remove the color bodies. One could design a separate alkaline or acid process to hydrolyze the remaining linkages however, this would involve another reactor system that might result in longer run times, yield loss and an increase in chemical waste. A resin-based system as described herein allows for a continuous, flow through process that reduces time and capital and operating expenses.

The methods described herein may be further understood in connection with the following Examples. In addition, the following are non-limiting examples provided to illustrate the invention. However, the person skilled in the art will appreciate that it may be necessary to vary the procedures for any given embodiment of the invention, e.g., vary the order or steps and/or the chemical reagents used herein. Products may be purified by conventional techniques that will vary, for example, according to the amount of side products produced and the physical properties of the products.

Definitions

Ion exchange chromatography is a process that separates ions and polar molecules based on their affinity to the ion exchanger. Ion exchange works on almost any kind of charged molecule. Anion exchange is when the stationary phase (the “resin”) is positively charged and negatively charged molecules are attracted to it. Cation exchange is used when the molecule of interest is positively charged and the stationary phase is negatively charged.

Reverse Osmosis water (RO water) is a high purity water that has passed through a very high performance membrane filtration process to remove almost all impurities.

Refractometers measure the extent of light refraction (as part of a refractive index) of transparent substances in a liquid; this is then used in order to identify a liquid sample, analyze the sample's purity and/or determine the amount or concentration of dissolved substances within the sample. Readings are delivered in degrees Brix units.

Degrees Brix is based on the sugar content of an aqueous solution. One degree Brix is 1 gram of sucrose in 100 grams of solution and represents the strength of the solution as a percentage of mass. If the solution contains dissolved solids other than pure sucrose, then the Brix only approximates the dissolved solid content.

### EXAMPLE 1

Ion Exchange Procedure for Removal of Color Bodies from XOS

Purpose

The purpose of the ion exchange process is to decolorize the product. Color bodies and other contaminants are adsorbed to the resin and more pure XOS product elutes from the column. Proper use and regeneration of the system is necessary to maintain the efficiency of the color removal step as well as helping to ensure that the finished product meets quality and performance standards.

Procedure for Ion exchange separation

Fresh resin is charged with NaOH according to manufacturer's instructions and then flushed with RO water until the pH of the effluent in less than 10.5 (preferably less than 10.2).

The ion exchange columns having the dimensions of 48″ i.d.×82″ ht. were filled to approx 72″ with resin. The columns are run at room temperature, though it is possible to run at elevated temperature. Reverse osmosis water is used as the solvent. Crude XOS product (from ultrafiltration) is pumped onto the column at a flow rate of 2-6 bed volumes (BV)/hr. When Brix reaches 0.1 the effluent is collected into a clean, sanitized tote. As an example, feed crude XOS concentration was 10 g/L (total dissolved solids (TDS) content approx 20 g/L) and eluted XOS concentration of approx. 6 g/L and TDS of 10 g/L.

After the XOS product tote is emptied 1 BV of RO water is passed over the column at the same flow rate to “push” remaining product through the bed.

Brix is monitored every 15-30 min until 0 is achieved and at that point collection is discontinued.

The colorless, product XOS solution is then obtained having a concentration of approx 6 g/L, which is further concentrated via reverse osmosis and then dried to a white to tan powder using a variety of methods including, but not limited to, spray drying, drum drying, refractance window drying, and the like.

Ion Exchange Regeneration

Through the periodic monitoring (every 15 minutes) of 420 nm wavelength light absorbance as well as the pH of a sample of the liquid exiting the ion exchange columns, the operator will be able to determine when the column's color removal effectiveness is decreasing/depleted. Further passing of additional liquid product through the columns will be ineffective and even counterproductive (may increase in color at it washes the bound color bodies off the resin as it passes through).

When this loss in effectiveness is observed, the operator will make note in the records and halt the pumping of the color containing liquid product through the columns. The discharge line from the columns will be diverted into a separate container for collection.

Clean Reverse Osmosis (RO) water will then be pumped through the columns in the same flow direction through the system as was done with the product. This process will flush as much the product liquid from the columns as possible. By using a refractometer, the operator can monitor when the level of dissolved solids in the liquid exiting the columns has decreased below 0.25° Brix. This shows that most of the product containing liquid has been removed from the columns. The flushing with RO water will result in a diluted product that is potentially higher in color and will require reprocessing through the column after regeneration.

Due care must be taken to ensure that proper personal protective items are available and worn during the mixing and handling of the caustic regenerating solution both before use and as it discharges from the columns.

Next, flushing with RO water is paused, and the flow system adjusted to ensure that the flow of RO water is now in the opposite direction (countercurrent backwashing) of previous flow of our process liquids through the columns. Collection of the liquids exiting the columns should be collected separate “waste” vessel as it will contain high levels of color compounds (which are not desired in our product) and ultimately the regeneration caustic solution.

During the backwashing process, fluidizing the resin bed occurs by pumping water upward direction through the columns. By lifting and separating the beads, backwashing aids in thorough cleaning of the bed and also allows the beads to reclassify in the bed, improving flow distribution. Backwashing removes residual product, some color compounds, resin fines, microorganisms, and other matter to allow good regenerant contact and flow through the bed. Screened backwash outlets will help prevent backwash expansion from pushing the resin beads from the columns.

Regeneration of the resins will also be done in this countercurrent flow direction. This helps ensure that impurities flushed from the resins with the highest level of bound color (found at the inlet side or top of the column), can easily exit the system instead of having to be washed through the entire bed.

Next, a solution 4% Sodium Hydroxide (in water) will be made by diluting the needed amount of a purchased 50% solution of High Purity Sodium Hydroxide (rayon grade) with the appropriate volume of RO water. This 4% Sodium Hydroxide solution will be pumped through the columns at slow rate of 1 gpm. This slow rate will ensure adequate contact time with the resin to maximize color extraction and charge the beads. Pumping will continue until the level of visible color being removed from the columns is minimized or removed. At the completion of this caustic wash, the pH of the solution in the column will be in excess of pH 12. If needed, the resin can be held at this pH for extended storage between processing runs or between shifts. Ensure that the columns are properly labelled as to the status of regeneration and to the contents of the columns if not to be immediately put back into service.

Alternatively, the operator may choose to use 1% NaOH, 10% NaCl as the regenerant (“caustic brine”) if the resin is heavily fouled. This is a more aggressive cleaning of the resin and may be required if very dark product solutions have been used in the column. If so the operator should follow the instructions from DuPont in the technical document “Procedure for brine cleaning of anion resins”.

At the completion of the caustic regeneration or storage, RO water will be flushed through the resin columns to continue to remove any remaining color impurities and the regenerating caustic solution. It will take larger quantities of RO water to be continuously flushed through the system to return the columns to a pH of approximately 10. The flow of RO water should be paused, the system valving adjusted to put the system back into forward flow and started again. When the pH of the water in forward flow is at or below pH 10, the columns are ready to be returned into service for the removal of color compounds (color bodies).

The ion exchange feed material (i.e., crude product and/or starting materials) can now be introduced back into the Ion Exchange columns. The operator will monitor the Brix measurement on the liquid exiting the columns. Until the liquid shows a Brix measurement over 0.25 it is sent to the waste tank. After a 0.25° Brix reading, the liquid stream should be sent to the collection vessels for product.

In this manner, the process is shown to be adaptable for use as a continuous flow. Alternatively, the process may be performed in batch mode on semi-prep or pilot plant scale.

### EXAMPLE 2

Decolorization Trials for PRENEXOS™

In accordance with Example 1, the following components were tested.

1. Activated Charcoal

Activated carbon filtration is a commonly used technology based on the adsorption of contaminants on the surface of the filter. This method is effective in removing certain organics, chlorine, fluorine or radon from drinking water or wastewater. The characteristics of the chemical contaminant are important. Compounds that are less water-soluble are more likely to be adsorbed to a solid. The affinity depends on the charge and is higher for molecules possessing less charge. The mechanism tends to be hydrophobic interaction.

2. Ion Exchange

Ion exchange is the reversible interchange of ions between a solid (the resin) and a liquid in which there is no permanent change in the structure of the solid. Ion exchange has been used for a wide range of applications including:

a. Water softening

b. Dealkalization

c. Demineralization

d. Condensate polishing

e. Ultra-pure water

f. Nitrate removal

g. Waste treatment

h. Chemical processing—catalysis

i. Purification

j. Metal extraction, separation and concentration

k. Desiccation

l. Sugar separations and purifications

m. Chromatographic separation

n. Pharmaceuticals

o. Fermentation

3. Adsorbents

Polymeric adsorbents are highly porous structures, whose internal surface can adsorb and then desorb a wide variety of different molecules depending on the environment in which they are used.

Resins tested for PRENEXOS™ purification

TABLE 4

| Resin | Description | Applications |
|---|---|---|
| Amberlite FPA-22 | Macroporous, Type II strong | Sweetener mix bed polishing |
| | base anion resin containing | |
| | dimethylethanolamine | |
| | functionality on styrene- | |
| | divinylbenzene matrix | |
| Amberlite FPA-98 | Macroporous. Type I strong | Cane sugar decolorization |
| | base anion exchange resin | Bioprocessing decolorization |
| | containing trimethylammonium | Heparin purification |
| | functionality on a crosslinked | |
| | acrylic matrix | |
| Amberlite FPX-66 | Polymeric adsorbent; | Food processing |
| | macroporous. non- | Decolorization |
| | functionalized crosslinked | Purification |
| | aromatic polymer | Recovery of high-value |
| | | materials |
| | | Biopharmaceutical processing |
| | | Separation of small |
| | | molecular weight |
| | | compounds |
| Amberlite FPA-90 | Macropouros, Type I strong | Cane sugar decolorization |
| | base anion exchange resin | Antibiotic decolorization |
| | containing trimethylammonium | |
| | functionality on a styrene- | |
| | divinylbenzene matrix | |
| Amberlite FPA-51 | Macroporous, weakly basic | Nutrition applications |
| | anion exchange resin containing | Sweetener deashing |
| | tertiary amine functionality on a | Sweetener |
| | crosslinked polystyrene matrix | deacidification |
| | | Sweetener |
| | | decolorization |
| | | Bioprocessing applications |
| | | decolorization |
| Amberlite XAD-4 | Polymeric adsorbent - aromatic | Adsorption of organic |
| | | substances from aqueous |
| | | systems and polar solvents |
| Activated carbon | Organic adsorbent; physical and | Water purification, fluegas |
| | chemical adsorption | treatment, chemical processing |
| | | applications |

In accordance with Table 4 above, certain resins were employed to test, among other parameters, release of acetate, recovery and/or purity of XOS (% solids), and absorption values based on adsorbed color bodies. Results are summarized in Table 5, below.

TABLE 5

| Resin | Summary of use with PRENEXOS ™ |
|---|---|
| Amberlite FPA-22 | Very high release of acetic acid from XOS |
| | Adsorbed XOS |
| | Adsorbed color |
| Amberlite FPA-98 | Moderate release of acetic acid from XOS |
| | High XOS recovery |
| | Adsorbed color |
| Amberlite FPX-66 | No release of acetic acid |
| | Adsorbed XOS |
| | Adsorbed color |
| Amberlite FPA-90 | No release of acetic acid |
| | High XOS recovery |
| | Adsorbed color |
| Amberlite FPA-51 | Moderate release of acetic acid |
| | High XOS recovery |
| | Adsorbed color |
| Amberlite XAD-4 | Low release of acetic acid |
| | Adsorbed XOS |
| | Adsorbed color |
| Activated carbon | Adsorbed XOS and color |

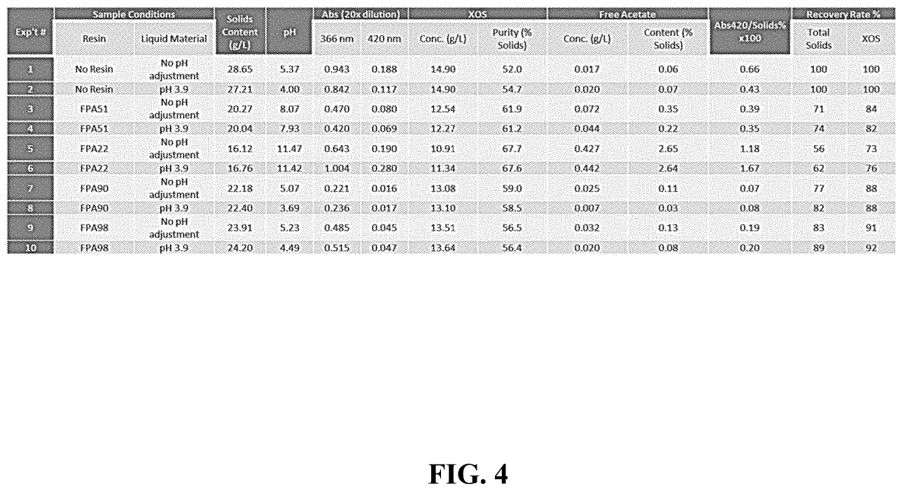

In accordance with the above components, as shown in FIG. 4, trials were carried out with FPA51, FPA90, FPA98 and FPA22.

Absorbance at 420nm is indicative of color, i.e. a low Abs420 is less colored. For example, feed starting material is much higher in color than any of the samples exposed to FPA51.

As shown in FIG. 4, “Free acetate” is the concentration of acetate (g/L) released into solution. Also, total XOS content is a measurement of the purity of XOS (% solids).

The following results for certain resins were found as tabulated in FIG. 4.

FPA51: After mixing with the resin the free acetic acid (i.e. acetate) content increased, the color decreased and the XOS purity was high.

FPA22: After mixing with FPA 22 the material had very high pH, very dark color, and high HOAc (i.e. acetate), which are not desirable. However, the result shows that more XOS was absorbed by FPA22 than other resins, and that acetic level increased dramatically with this resin.

FPA90: The liquid material after resin absorption did not have a raised pH or free acetic acid (i.e. acetate). The resin was very good at de-color the material and absorb not so much XOS as FPA51 and FPA22. The only drawback of FPA90 is that it was not able to purify XOS as well as FPA 51 and FPA22.

FPA98: The Performance of this resin was similar to FPA90. The liquid material after 2 hours mixing with FPA98 had light color, low free acetic content, and high XOS recovery rate. pH increased slightly but still not that high as FPA51. It was not that good at purifying XOS as other resins.

The use of the terms “a,” “an,” “the,” and similar referents in the context of describing the present invention (especially in the context of the claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Use of the term “about” is intended to describe values either above or below the stated value in a range of approximately ±10%; in other embodiments, the values may range in value above or below the stated value in a range of approximately ±5%; in other embodiments, the values may range in value above or below the stated value in a range of approximately ±2%; in other embodiments, the values may range in value above or below the stated value in a range of approximately ±1%. The preceding ranges are intended to be made clear by context, and no further limitation is implied. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise stated. No language in the specification should be construed as indicating any non-claimed element as essential to the practice of the invention.

While in the foregoing specification this invention has been described in relation to certain embodiments thereof, and many details have been put forth for the purpose of illustration, it will be apparent to those skilled in the art that the invention is susceptible to additional embodiments and that certain of the details described herein can be varied considerably without departing from the basic principles of the invention.

All references cited herein are incorporated by reference in their entireties. The present invention may be embodied in other specific forms without departing from the spirit or essential attributes thereof, and, accordingly, reference should be made to the appended claims, rather than to the foregoing specification, as indicating the scope of the invention.

What is claimed is:

1. A method for making a xylo-oligosaccharide material, comprising the steps of:
(a) providing a feedstock xylo-oligosaccharide material in aqueous solution including xylose monomer units comprising formula (I): 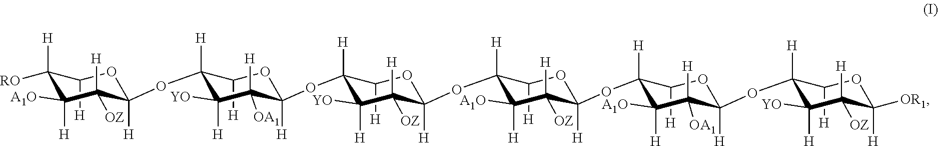
wherein R and R₁ are each independently selected from hydrogen or one or more xylose monomer units,
A₁ is selected from hydrogen or acetyl,
Y is selected from the group consisting of hydrogen, arabinose (arabinosyl), galactose (galactosyl), ribose (ribosyl), mannose (mannosyl), glucuronic acid (glucuronosyl), and glucose (glucosyl),
Z is selected from the group consisting of hydrogen, glucuronic acid (glucuronosyl), galacturonic acid (galacturonosyl), and mannuronic acid (mannuronosyl),
optionally, Y and Z can be exchanged one for another, and
wherein either of Y or Z is further substituted on a sugar hydroxyl as a cinnamate ester, the positions of the phenyl group -meta, -para, -meta are each independently selected from hydrogen, hydroxyl, or methoxy;
(b) adding the xylo-oligosaccharide solution to an ion-exchange resin; and
(c) eluting the xylo-oligosaccharide solution to provide a decolorized solution containing purified xylo-oligosaccharide.

2. The method of claim 1, wherein the feedstock xylo-oligosaccharide solution contains about 10 g/L to about 20 g/L total dissolved solids.

3. The method of claim 1, wherein the decolorized solution contains about 6 g/L to about 14 g/L purified xylo-oligosaccharide.

4. The method of claim 1, wherein the decolorized solution contains about 50% by weight to about 70% by weight based on total solids of purified xylo-oligosaccharide.

5. The method of claim 1, wherein A₁ is acetyl in about one in six xylose monomer units.

6. The method of claim 1, wherein the cinnamate is present in an amount of about 1% by weight based on total solids.

7. The method of claim 1, wherein the decolorized solution contains about 0.01 g/L to about 0.5 g/L free acetate.

8. The method of claim 1, wherein the decolorized solution contains about 0.01% by weight to about 3% by weight based on total solids of free acetate.

9. The method of claim 1, wherein the decolorized solution has an OD₄₂₀ absorbance of less than about 0.1.

10. The method of claim 1, wherein the feedstock solution has an OD₄₂₀ absorbance of greater than 0.1.

11. The method of claim 1, wherein the ion exchange resin is selected from the group consisting of FPA22, FPA51, FPA90, and FPA98.

12. The method of claim 1, further comprising the step of:
(d) drying the decolorized solution to provide a white or off white powder.

13. The method of claim 12, wherein the white powder provides a xylooligosaccharide mixture having a degree of polymerization (DP) of about DP3 to about DP12, based on xylose monomer units.
